(19) United States
(12) Patent Application Publication
(10) Pub. No.: US 2024/0184008 A1
(43) Pub. Date: Jun. 6, 2024

(54) SYSTEM AND METHOD FOR MULTIPLE PREDICTION WITH ANGULAR DEPENDENT REFLECTIVITY

(71) Applicant: CGG SERVICES SAS, Massy Cedex (FR)

(72) Inventors: Gordon POOLE, East Grinstead (GB); Milad FARSHAD, Crawley (GB)

(21) Appl. No.: 18/456,862

(22) Filed: Aug. 28, 2023

Related U.S. Application Data
(60) Provisional application No. 63/430,192, filed on Dec. 5, 2022.

(51) Int. Cl. G01V 1/36

(52) U.S. Cl. CPC G01V 1/362; G01V 2210/59

(57) ABSTRACT

A method for removing multiples m from seismic data d associated with a subsurface, the method including receiving the seismic data d associated with the subsurface, forward propagating the seismic data d into the subsurface to form forward propagated data d_{Φ}; receiving angular dependent reflectivities r_{θ}, associated with an angular range Δθ, in the subsurface, for a given point; generating an angle dependent reflecting wavefield D_{Φθ}r_{θ} based on the forward propagated data d_{Φ} and the angular dependent reflectivities r_{θ}; calculating a multiple model ΦD_{Φθ}r_{θ} by forward propagating the angle dependent reflecting wavefield D_{Φθ}r_{θ} to the receiver; attenuating multiplies m associated with the multiple model, from the seismic data d, by subtraction of the multiple model to calculate demultiple data dd; and generating an image of the subsurface.

### BACKGROUND

### Technical Field

Embodiments of the subject matter disclosed herein generally relate to processing seismic data acquired over land or water and, more specifically, to identifying multiples, which are included in the recorded seismic data, based on a wave equation deconvolution approach that is sensitive to the angular characteristics of the waves, and removing the multiples from the recorded seismic data.

### Discussion Of The Background

Hydrocarbon exploration and development uses waves (e.g., seismic waves or electromagnetic waves) to explore the structure of underground formations on land and at sea (i.e., formations in the subsurface). These waves are collected during a seismic acquisition campaign, either on land or on water. Energy generated by a seismic source propagates as seismic waves downward into a geological formation, and part of the energy is reflected and/or refracted back up to the surface. Characteristics of the reflected/refracted energy detected by seismic sensors are used to produce an image of the earth's reflectivity.

As schematically illustrated in FIG. 1, when a marine seismic acquisition system 100 is used, waves 112 emitted by a source 110 at a known location penetrate an unexplored formation 120, which is located below the water bottom 106, and are reflected at plural interfaces 122, 124, 126 that separate the formation's layers, as they have different layer impedances. Sensors 130 (only one shown for simplicity), which are distributed along a streamer 132 towed by a vessel 102 (for the case of a marine seismic survey), detect the reflected waves 140, 150. The detected waves 140, 150 include primary reflections such as wave 140, which travel directly from a formation interface to a sensor, and multiple reflections such as wave 150, which additionally undergo at least one more downward reflection and one upward reflection. In the case of the multiple 150 in this embodiment, the downward reflection is at the water surface 104 and the upward reflection is at reflector 122. Note that, as used herein, the term “formation” refers to any geophysical structure into which source energy is promulgated to perform seismic surveying, e.g., land or water based, such that a “formation” may include a water layer when the context is marine seismic surveying. A similar picture may be used to describe the rays for a land seismic survey, except that there is no reflection from the water surface as there is no water.

The recorded seismic waves include primary arrivals and multiples. Most of the existing processing methods are designed to work best with the primary arrivals and thus, for these methods, the multiples need to be attenuated or fully removed. While there are methods adapted to work with the primary and the multiples, the multiples need to be identified and labeled as such. Thus, there is a continuous interest in the industry to separate and classify the primary arrivals and multiples.

However, as is known in the seismic field, some of the current methods can be ineffective under certain conditions/environments, for example, for waves having different angular characteristics at a given reflection point. This means that the reflectivity in the existing methods is angle invariant, i.e., an arrival incoming at 10 degrees will be reflected with the same amplitude as an arrival incoming at 40 degrees, which is not the case in many practical situations. Therefore, multiples removal remains a subject of continuing research, with new opportunities and challenges occurring as data acquisition systems evolve.

### SUMMARY

According to an embodiment, there is a method for removing multiples m from seismic data d associated with a subsurface. The method includes receiving the seismic data d associated with the subsurface, wherein the seismic data d includes primaries and multiples m recorded by a receiver, forward propagating the seismic data d into the subsurface to form forward propagated data d_{Φ}, receiving angular dependent reflectivities r_{θ}, associated with an angular range Δθ, in the subsurface, for a given point, generating an angle dependent reflecting wavefield D_{Φθ}r_{θ} based on the forward propagated data d_{Φ} and the angular dependent reflectivities r_{θ}, calculating a multiple model ΦD_{Φθ}r_{θ} by forward propagating the angle dependent reflecting wavefield Deere to the receiver, attenuating multiplies m associated with the multiple model, from the seismic data d, by subtraction of the multiple model to calculate demultiple data dd, and generating an image of the subsurface indicative of geophysical features associated with a natural resource, carbon capture monitoring or wind turbine placement, based on the demultiple data dd.

Any of the following features may be combined with the above noted embodiment. In one application, the associated angular range Δθ is between −50 and +50 degrees. The step of receiving the angular dependent reflectivities r₇₄ includes receiving a first angular dependent reflectivity r_{θ1}, associated with a first angular range, and a second angular reflectivity r_{θ2},associated with a second angular range, wherein the first angular range together with the second angular range form the angular range Δθ. The angular dependent reflectivities are calculated with a least square inversion method. The multiple model ΦD_{Φθ}r_{θ} is calculated by simultaneously forward propagating plural angle dependent reflecting wavefields D_{Φθ}r_{θ} to the receiver. The step of generating an angle dependent reflecting wavefield involves converting the angle dependent reflectivity to a subsurface offset domain Sr_{θ} and accumulating a reflection from a first subsurface offset with a reflection from a second subsurface offset D_{ΦS}Sr_{θ}. The forward propagated data is offset in space, at the given point, with a subsurface offset h to generate a reflection. The forward propagated data is dip filtered to a first angular range to create a first angular range forwards propagated wavefield. The first angular range forwards propagated wavefield is reflected from a first reflectivity corresponding to the same first angular range. The subtraction is an adaptive subtraction.

According to another embodiment, there is a computing system for removing multiples m from seismic data d associated with a subsurface. The computing system includes an interface configured to receive the seismic data d associated with the subsurface, wherein the seismic data d includes primaries and multiples m recorded by a receiver, and a processor connected to the interface. The processor is configured to forward propagate the seismic data d into the subsurface to form forward propagated data d_{Φ}, receive angular dependent reflectivities r_{θ}, associated with an angular range Δθ, in the subsurface, for a given point, generate an angle dependent reflecting wavefield D_{Φθ}r_{θ} based on the forward propagated data d_{Φ} and the angular dependent reflectivities r_{θ}, calculate a multiple model ΦDeere by forward propagating the angle dependent reflecting wavefield D_{Φθ}r_{θ} to the receiver, attenuate multiplies m associated with the multiple model, from the seismic data d, by subtraction of the multiple model to calculate demultiple data dd, and generate an image of the subsurface indicative of geophysical features associated with a natural resource, carbon capture monitoring or wind turbine placement, based on the demultiple data dd. Any of the features discussed with regard to the method may be combined with the system of this embodiment.

In yet another embodiment, there is a method for removing multiples m from seismic data d associated with a subsurface and the method includes receiving the seismic data d associated with the subsurface, wherein the seismic data d includes primaries and multiples m recorded by a receiver, forward propagating the seismic data d into the subsurface to form forward propagated input data, receiving a first angular dependent reflectivity r_{θ1}, associated with a first angular range Δθ₁, in the subsurface, for a given point, and a second angular dependent reflectivity r_{θ2},associated with a second angular range Δθ₂, in the subsurface for the given point, generating a first reflecting wavefield using the forward propagated input data and the first angular dependent reflectivity r_{θ1}, generating a second reflecting wavefield using the forward propagated input data and the second angular dependent reflectivity r_{θ2},calculating a multiple model based on (1) the first reflecting wavefield, (2) the second reflecting wavefield, and (3) a forward propagating operator Φ, which is applied to each of the first and second reflecting wavefields, attenuating the multiplies m from the seismic data d by subtraction of the multiple model to calculate demultiple data dd, and generating an image of the subsurface indicative of geophysical features associated with a natural resource, carbon capture monitoring or wind turbine placement, based on the demultiple data dd.

The method may also include any of the following features. The method may include forward propagating the first reflecting wavefield to the receiver, forward propagating the second reflecting wavefield, independent of the first reflecting wavefield, to the receiver, and combining the forward propagated first and second wavefields at the receiver, to obtain the multiple model. The method may also include applying a first muting matrix M₁, to the forwards propagated first reflected data, and applying a second muting matrix M₂ to the forwards propagated second reflected data, wherein the first muting matrix M₁ mutes all data not associated with the first angular dependent reflectivity r_{θ1} and the second muting matrix M₂ mutes all data not associated with the second angular dependent reflectivity r_{θ2},and summing the muted forward propagated wavefields to calculate the multiples m. The method may further include estimating the multiples m by combining the first and second reflecting wavefields D_{Φ1}r_{θ1}, D_{Φ2}r_{θ2} to obtain a combined reflecting wavefield, and propagating the combined reflecting wavefield to the receiver, with the forward propagation operator Φ. The forward propagated input data is dip filtered to a first angular range prior to reflecting from the first angular dependent reflectivity, and the input data is dip filtered to a second angular range prior to reflecting from the second angular dependent reflectivity. The angular dependent reflectivities are calculated with a least square inversion method. The first angular dependent reflectivity is derived by solving a first inversion problem, and the second angular dependent reflectivity is derived by solving a second inversion problem. The first angular dependent reflectivity and the second angular dependent reflectivity are derived jointly by solving a single inversion problem. The first and second angle ranges Δθ₁, Δθ₂ corresponding to the first and second reflectivities r_{θ1} and r_{θ2} are the same as the angle ranges of the first and second muting matrices M₁ and M₂. The first and second angle ranges Δθ₁, Δθ₂ corresponding to the first and second reflectivities r_{θ1} and r_{θ2} are different from the angle ranges of the first and second muting matrices M₁ and M₂.

According to yet another embodiment, there is a computing system for removing multiples m from seismic data d associated with a subsurface. The system includes an interface configured to receive the seismic data d associated with the subsurface, wherein the seismic data d includes primaries and multiples m recorded by a receiver, and a processor connected to the interface and configured to forward propagate the seismic data d into the subsurface to form forward propagated input data, receive a first angular dependent reflectivity r_{θ1}, associated with a first angular range Δθ₁, in the subsurface, for a given point, and a second angular dependent reflectivity r_{θ2}, associated with a second angular range Δθ₂, in the subsurface for the given point, generate a first reflecting wavefield using the forward propagated input data and the first angular dependent reflectivity r_{θ1}, generate a second reflecting wavefield using the forward propagated input data and the second angular dependent reflectivity r_{θ2}, calculate a multiple model based on (1) the first reflecting wavefield, (2) the second reflecting wavefield, and (3) a forward propagating operator Φ, which is applied to each of the first and second reflecting wavefields, attenuate the multiplies m from the seismic data d by subtraction of the multiple model to calculate demultiple data dd, and generate an image of the subsurface indicative of geophysical features associated with a natural resource, carbon capture monitoring or wind turbine placement, based on the demultiple data dd. Any of the features discussed above with the method embodiment may be added to this system.

According to yet another embodiment, there is a non-transitory computer readable medium including computer executable instructions, wherein the instructions, when executed by a processor, implement any of the methods discussed above.

### BRIEF DESCRIPTION OF THE DRAWINGS

The accompanying drawings, which are incorporated in and constitute a part of the specification, illustrate one or more embodiments and, together with the description, explain these embodiments. In the drawings:

FIG. 1 is a schematic diagram illustrating a marine seismic data acquisition system that acquires primaries and multiples;

FIG. 2 is a flow chart of a method for multiple calculation and removal of the multiples from the seismic data based on muting matrices;

FIGS. 3A to 3C schematically illustrate the forward propagation and reflections performed on the seismic data for calculating the multiples based on angle independent reflections;

FIGS. 4A to 4C schematically illustrate the forward propagation and reflections performed on the seismic data for calculating the multiples based on angle dependent reflections transformed into subsurface offsets;

FIG. 5 is a flow chart of a method for multiple calculation and removal of the multiples from the seismic data based on subsurface offsets;

FIG. 6A is a schematic illustration of a sequential approach method for attenuating multiples from seismic data while FIG. 6B is a schematic illustration of a simultaneous approach method for attenuating the multiples;

FIG. 7 illustrates the method of FIG. 6A in terms of the starting reflectivity, the modelled data, and the calculated multiples;

FIG. 8 illustrates the method of FIG. 6B in terms of the starting angle domain data, the surface-offset domain obtained from the angle domain data, and the calculated multiples; and

FIG. 9 is a schematic diagram of a computing device configured to implement methods for processing data according to the embodiments discussed herein.

### DETAILED DESCRIPTION

The following description of the exemplary embodiments refers to the accompanying drawings. The same reference numbers in different drawings identify the same or similar elements. The following detailed description does not limit the invention. Instead, the scope of the invention is defined by the appended claims. The following embodiments are discussed, for simplicity, with regard to a marine seismic data acquisition. However, similar embodiments and methods may be used for a land data acquisition system.

Reference throughout the specification to “one embodiment” or “an embodiment” means that a particular feature, structure or characteristic described in connection with an embodiment is included in at least one embodiment of the subject matter disclosed. Thus, the appearance of the phrases “in one embodiment” or “in an embodiment” in various places throughout the specification is not necessarily referring to the same embodiment. Further, the particular features, structures or characteristics may be combined in any suitable manner in one or more embodiments.

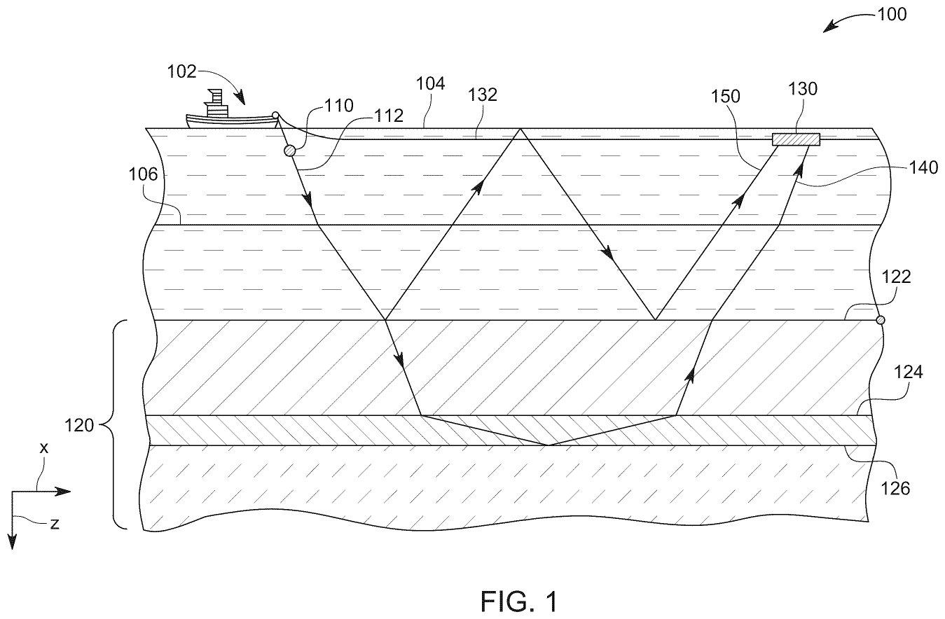

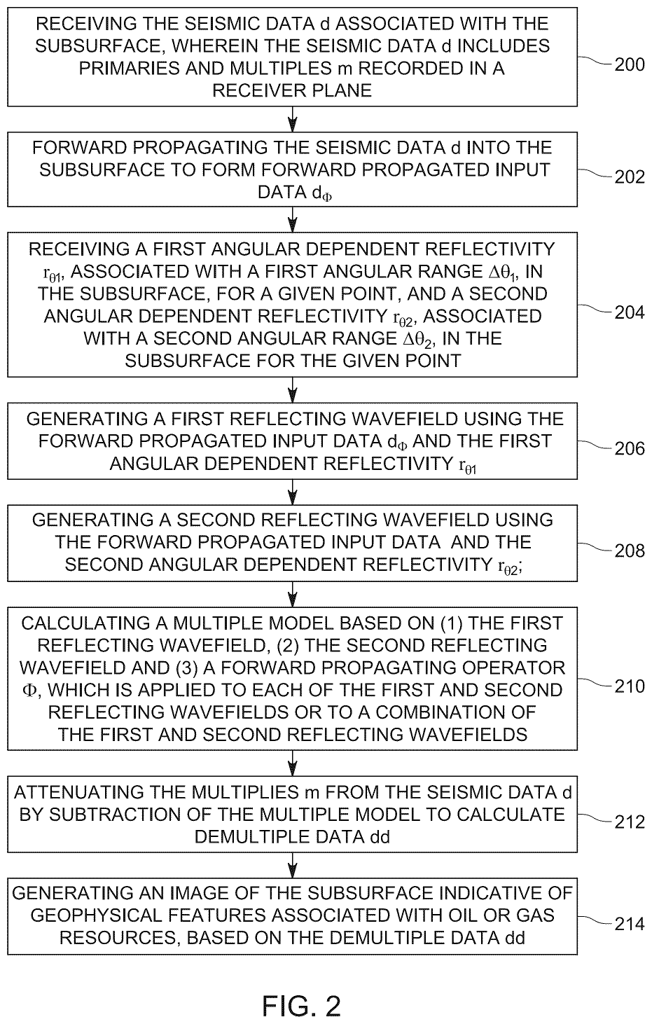

According to various embodiments, a process or method of multiple attenuation based on angle dependent reflectivity is implemented based on a multiple model that accounts for the incidence angle of the waves at the reflecting surface. More specifically, as schematically illustrated in FIG. 2, the method includes a step 200 of receiving input data d containing a multiple content. In this embodiment, the input data d is the seismic data acquired with the marine seismic acquisition system 100 illustrated in FIG. 1. One skilled in the art would understand that the seismic data may be acquired with a land seismic acquisition system, ocean bottom sensors, towed streamers, distributed acoustic sensing or other systems. In step 202, the input data dis forward propagated, from the receivers (or receivers plane if all the receivers are distributed in a single plane; note that in one application, the receivers may be distributed along a curve and thus, for this case, the input data is propagated from the location of each receiver) into the subsurface, to form forward propagated input data d_{Φ}. The various operators used in this method to propagate the data are based on wave propagation, for example based on [11]. In step 204, the method receives a first angular dependent reflectivity r_{θ1}, which is associated with a first reflection angle range, Δθ₁, that the wave may experience. The calculation of the first reflectivity is discussed later. As discussed above, for a same point (x, y, z) in the subsurface, it is possible to have different reflectivities r_{θ1}, and r_{θ2}, depending on the reflection angle θ. The definition of the reflection angle may refer to the incoming wave, the reflecting wave, or the angle difference between the incoming and reflecting wave. Thus, the reflectivity in this method is angle dependent, i.e., the first reflectivity r_{θ1} at a given point in the subsurface will be different from a second reflectivity r_{θ2} at the same given point, if they correspond to different reflection angles Δθ₁ and Δθ₂. As discussed later in more detail, it is possible to define reflection angle ranges Δθ₁, Δθ₂. The reflection angle ranges may be the same for each reflection angle or may be different. The angle of incidence ranges may be finely sampled, e.g., 1 degree, or coarsely sampled, e.g., 15 degrees. The angle ranges may overlap or may not overlap. Two reflection angles with the same range will produce corresponding reflectivities that are the same.

In step 204, the method also receives the second angular dependent reflectivity r_{θ2}, associated with the second angular range Δθ₂, in the subsurface for the given point. Note that the method may receive many angular dependent reflectivities, depending on the chosen reflectivity range. In one application, it is possible to have up to 80 different angular dependent reflectivities.

In step 206, a first reflecting wavefield D_{Φ}r_{θ}_{₁} is generated at the given point (x, y, z) in the subsurface, using (1) the forward propagated input data d_{Φ} and (2) the first angular dependent reflectivity r_{θ}_{₁}. Because the first reflecting wavefield D_{Φ}r_{θ}_{₁} accounts only for the reflecting waves associated with the angle range Δθ₁, in step 208, a second reflecting wavefield D_{Φ}r_{θ}_{₂} is generated at the given point (x, y, z) in the subsurface, using (1) the forward propagated input data d_{Φ} and (2) the second angular dependent reflectivity r_{θ}_{₂}. Note that in this notation, the forward propagated data d_{Φ} is organized into a matrix D_{Φ} to be convolved with the reflectivity. The convolution may relate to a multiplication in the frequency domain. If more angle dependent reflectivities are used, then more reflecting wavefields are generated before the next step, until all the angle dependent reflectivities are used up. In step 210, a multiple model is calculated based on (1) the first reflecting wavefield, (2) the second reflecting wavefield, and (3) a forward propagating operator Φ, which is applied to either each of the first and second reflecting wavefields or a combination of the first and second reflecting wavefields. In step 212, the calculated multiple model is used to attenuate the multiples in the input data d, for example, by subtraction, to obtain the demultiple data dd.

In the embodiment discussed above, only two angle ranges per reflection point were considered. However, the method may be extended to three or more ranges. In one step of the method, the first reflecting wavefield and the second reflecting wavefield are combined to generate a combined reflecting wavefield, and the combined reflecting wavefield is used to attenuate multiples in the input data. In another step, the first reflecting wavefield is forward propagated to the receiver positions, the second reflecting wavefield is forward propagated to the receiver positions. In yet another variation, the combined reflecting wavefield is forward propagated to the receiver positions. In yet another step of the method, the first reflecting wavefield and the second reflecting wavefield are combined to generate a combined reflecting wavefield, and the combined reflecting wavefield is forward propagated, to the receiver plane, with the forward propagating operator Φ, as a single wavefield. For this step, the two or more angular dependent reflectivities may be transformed, as discussed later in more detail, to a plurality of subsurface offset reflectivities and these subsurface offset reflectivities may be scaled by laterally shifted forward propagated input data d_{Φ} around the given point. The plurality of reflecting wavefields corresponding to the plurality of subsurface offset reflectivities may be combined prior to subsequent forwards propagation to the receiver. In other words, the method illustrated in FIG. 2 may be implemented (1) to have all the reflecting wavefields combined in the subsurface, and to simultaneously forward propagate the combined reflecting wavefield with the forward propagating operator Φ to the receiver plane, or (2) to sequentially propagate each reflecting wavefield (no combination) to the receiver plane, with the forward propagating operator Φ. These two different implementations of the method illustrated in FIG. 2, called herein the “simultaneous” approach and the “sequential” approach, are discussed in more detail next. Those skilled in the art would understand that various other variations may be implemented to the method illustrated in FIG. 2.

In step 214, the method generates an image, based on the demultiple data dd, of the subsurface indicative of geophysical features associated with a natural resource (for example, oil or gas resources), carbon capture monitoring or wind turbine placement. In one application, the image of the subsurface is used for identifying other resources, for example, ore, minerals, or for determining potential CO₂ storage reservoirs, geothermal resources or wind turbine placement. In other words, the image generated with the method discussed above may be used for any purpose related to identifying a subsurface feature.

The method of FIG. 2 follows a wave-equation deconvolution approach for multiple modelling. The “sequential” approach is detailed next. The input data d that is used for calculating the multiples may be data recorded by any sensor type, examples include hydrophones, geophones, particle motion sensors, particle velocity sensors, accelerometers, near-field hydrophones, near-field accelerometers or other sensor configured to detect seismic energy. The data may be from towed streamer, ocean-bottom sensor, OBS, (node or cable) acquisition, land acquisition, transition zone campaign, or borehole (e.g., vertical seismic profile (VSP), distributed acoustic sensing (DAS)). The image of the subsurface may be used to identify/interpret/exploit a sub-surface resource, such as, but not limited to, oil and gas, geothermal, mineral reserves, etc.

The data may be recorded at a constant datum, or a variable datum (e.g., variable depth streamer, or varying topography in land, e.g., floating datum). In the case of land data, the geophone recordings may be propagated forwards and backwards to form the multiple image, and the multiple image may be used to predict multiples. In general, the terms OBN (ocean bottom node), OBC (ocean bottom cable), OBS (ocean bottom survey/sensor), and PRM (permanent reservoir monitoring) systems may be used interchangeably. The recorded data may be input to multiple imaging before or after wavefield separation. OBN receiver gather data may correspond to hydrophone, geophone (x, or, y, or, z), accelerometer, receiver-upgoing, receiver-downgoing, etc.

Reflectivity, also known as an image of the subsurface, the migrated image, or the image, is represented by the letter “r” herein and describes how the down-going (also known as the “source-side”) wavefield may change into the up-going (also known as the “receiver-side”) wavefield.

Seismic sources are used to generate the seismic waves, whose energies are then recorded by the various sensors as seismic data. The seismic source may be any type of seismic source, examples include airgun, pinger, sparker, boomer, marine vibrator, land vibrator, dynamite, etc. The source may be a single source (e.g., single airgun) or an array of sources (e.g., airgun array).

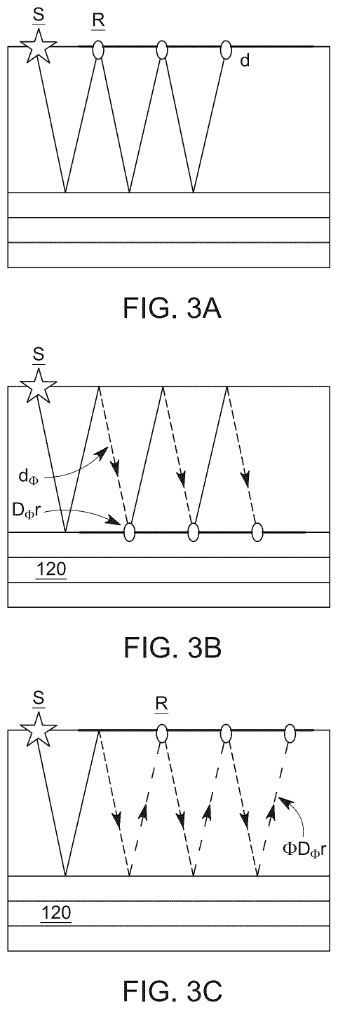

The steps 202, 206, and 208, when implemented for the “sequential” approach, are now discussed with regard to FIGS. 3A to 3C. To determine the multiple data 150 without depending on the angular component of the incoming wave, it is possible to use any known method in the field. For example, in one application, when primaries corresponding to the multiple generators have been recorded, approaches such as Surface-Related Multiple Elimination (SRME) [2] or Surface-Related Multiple Modelling (SRMM) [3] may be employed. In the case they have not been recorded, model-based multiple modelling approaches [4], deconvolution-based methods [5], or wave-equation deconvolution methods [1] may be used.

In this embodiment, the method of [1] is modified to become angle dependent and the modified method is used in steps 202, 206, and 208 for calculating the first and second reflectivities. The wave equation deconvolution prediction method in [1] includes a reflectivity derivation step and a multiple modelling step. The reflectivity derivation step involves the multiple modelling formula (see equation (1) below) and a corresponding optimization problem which is used to find the reflectivity r (see equation (2)):

m(t,x,y)=F⁻¹Φ(f,x,y,z)D_{Φ}(f,x,y,z)r(x,y,z), (1)

ε(r)=[d(t,x,y)−F⁻¹Φ(f,x,y,z)D_{Φ}(f,x,y,z)r(x,y,z)]², (2)

where D_{Φ} is the forwards propagated data in matrix form to convolve by the reflectivity, r is the reflectivity and is found from a least squares inversion, Φ is the forward propagation operator, f is the frequency, F⁻¹ is the inverse Fast Fourier Transform (FFT) operator, m is the multiples or more commonly data, and ε(r) is the sum of squares error, which is a function of the reflectivity r. Note that the formula shown in equation (1) is referred to herein as the “multiple model” while the result of that equation, i.e., m, represents the actual “multiples.” In this notation, data is propagated and reflected in the frequency domain before being reverse transformed to the time domain for comparison to the recorded data, d.

The reflectivity r of a plane/interface, as discussed above and used in the above noted multiples determination step, is understood herein to be an “image” of the surveyed subsurface. An image of the subsurface is generally understood to be a representation of the reflectivity in the earth, defined in space (x-z for 2D, and x-y-z for 3D). This may also be referred to as a migration, the migrated image or the reflectivity. Thus, these terms are used interchangeably herein. An image of the subsurface may be the result of a single-step or optimized migration.

In some embodiments, to form an image, an imaging condition may need to be applied to the data. In one application, the imaging condition is a mathematical function applied to the extrapolated down-going and up-going wavefields to form the image. The most common imaging condition is the cross-correlation imaging condition. Other options are the deconvolution imaging conditions, a variety of which are known in the field, for example, smoothing imaging condition, 2D deconvolution imaging condition or multi-dimensional deconvolution imaging condition.

The linear operations of equation (1) are pictorially illustrated in FIGS. 3A to 3C. FIG. 3A shows the recorded data d, which includes the primaries and the multiples (plus optionally the direct arrival). FIG. 3B shows the recorded data d being forward extrapolated (with the forward propagation operator Φ into the subsurface 120, and thus, it is represented in the figure as the forward propagated input data d_{Φ}), following which the forward propagated input data d_{Φ} is represented in matrix convolution form D_{Φ} and this data is reflected, i.e., D_{Φ}r, and is then forward extrapolated back to the surface ΦD_{Φ}r, as shown in FIG. 3C.

The forward propagation approach will estimate recordings that would have been made by receivers successively deeper in depth (for example with a 2 m increment) if the wavefield continued its path into the subsurface. This may define a forward propagated wavefield as a function of temporal frequency (f), lateral coordinate (x,y), and vertical coordinate (z); dΦ(f,x,y,z). A reflecting wavefield may correspond to the convolution of the forward propagated data dΦ(f,x,y,z) with reflectivity r(x,y,z). Expressing the forward propagated data in matrix form, this convolution may be considered as a matrix-vector multiplication. For one depth step (z1), two lateral positions in x (x1,x2), and three frequency slices (f1,f2,f3), this may be expressed as follows:

$${D}_{Φ} r = ( \begin{matrix}{d}_{Φ ( f 1 , x 1 , z 1 )} & {d}_{Φ ( f 1 , x 2 , z 1 )} \\ {d}_{Φ ( f 2 , x 1 , z 1 )} & {d}_{Φ ( f 2 , x 2 , z 1 )} \\ {d}_{Φ ( f 3 , x 1 , z 1 )} & {d}_{Φ ( f 3 , x 2 , z 1 )}\end{matrix} ) ( \begin{matrix}{r}_{( x 1 , z 1 )} \\ {r}_{( x 2 , z 1 )}\end{matrix} )$$

The inclusion of more depth steps would increase the number of columns in D_{Φ} and the number of rows r. The following example illustrates the addition of one extra depth-step:

$${D}_{Φ} r = ( \begin{matrix}{d}_{Φ ( f 1 , x 1 , z 1 )} & {d}_{Φ ( f 1 , x 2 , z 1 )} \\ {d}_{Φ ( f 2 , x 1 , z 1 )} & {d}_{Φ ( f 2 , x 2 , z 1 )} \\ {d}_{Φ ( f 3 , x 1 , z 1 )} & {d}_{Φ ( f 3 , x 2 , z 1 )}\end{matrix} \vert \begin{matrix}{d}_{Φ ( f 1 , x 1 , z 2 )} & {d}_{Φ ( f 1 , x 2 , z 2 )} \\ {d}_{Φ ( f 2 , x 1 , z 2 )} & {d}_{Φ ( f 2 , x 2 , z 2 )} \\ {d}_{Φ ( f 3 , x 1 , z 2 )} & {d}_{Φ ( f 3 , x 2 , z 2 )}\end{matrix} ) ( \frac{\begin{matrix}{r}_{( x 1 , z 1 )} \\ {r}_{( x 2 , z 1 )}\end{matrix}}{\begin{matrix}{r}_{( x 1 , z 2 )} \\ {r}_{( x 2 , z 2 )}\end{matrix}} )$$

The result of this matrix-vector multiplication will be a reflecting wavefield at every position in the subsurface ([D_{Φ}r](f, x, y,z)).

In reality there are many lateral (e.g., 1000 in x and 1000 in y) and vertical (e.g., 500 in z) positions as well as many frequencies (e.g., 1000 frequency slices), which would make the size of D_{Φ} very large. For this reason, matrix D_{Φ} is not explicitly formed, and instead model the data one frequency at a time.

Note that each of these steps is based on the wave equation, and thus, this is the reason why the method is based on wave equation deconvolution. This approach can also be used for OBN residual demultiple [6] and land surface related multiple attenuation [6]. As noted above, this approach may be used for determining the reflectivity r, which is not angle dependent, and then to calculate the multiples based on the method in [3].

To estimate the status of the seismic energy when moving from one location to another location in the subsurface, the concept of wavefield extrapolation, also known as wavefield propagation, is used. Seismic data extrapolation is a method to simulate recordings of a wavefield at a position other than that to which it was recorded. For example, for horizontal towed streamer acquisition, it is possible to record hydrophone measurements at a depth of 12 m. Then, it is possible to extrapolate these measurements to a new datum, for example, at 100 m depth. The extrapolation may use an estimate of the subsurface properties, e.g., velocity, anisotropy, absorption, etc. The extrapolation may be with one-way or two-way extrapolations and may be forward or reverse in direction.

With regard to step 202, the data dis propagated based on the method of [1], as exemplified in FIGS. 3A to 3C. The reflection of this propagated data, i.e., the reflections received in step 204, may be calculated as now discussed. The method in [1] explains that the method may be modified to use subsurface offsets (note that a subsurface offset is different from the traditional source-receiver offset, as the subsurface offset is considered in the subsurface, as spatial translation (normally in x and y (for fixed z)) between source and receiver wavefields prior to the imaging condition or time-shift gathers to accommodate inaccurate velocities or varying amplitude with the reflection angle. In the case of subsurface offsets, the reflectivity would be multi-valued where the reflectivity changes with the relative spatial displacement of the down-going and up-going wavefields. The subsurface offsets may be in one direction only, e.g., r(hₓ, x, y, z), or in more than one direction, e.g., r(hₓ, h_{y}, x, y, z). While the use of subsurface offsets provides the flexibility for the approach to be less tolerant to velocity errors and angular reflectivity values, in practice, it also adds additional degrees of freedom to the optimization problem which can result in overfitting or primary damage.

When an incoming wave hits a boundary (interface) in the subsurface, a portion of the energy will be reflected and another portion of energy will be transmitted. It is well known in the industry that the level of reflecting energy will vary with the reflection angle (see, [7]). The variation of amplitude with the reflection angle can be an indication of hydrocarbons in the subsurface. Further information on this topic can be found in [8] or [9]. In this embodiment, it is desired to improve the wave-equation deconvolution accuracy by allowing the amplitudes of the reflection r to vary with the reflection angle. In order to do this, according to a first approach, it is possible to mute the data for different reflection angle ranges Δθ within which it is assumed the reflection's amplitude to be constant. A very small reflection angle, for example 1 degree, would in theory be accurate, but over-muting of the input to such a small range would make the estimate unreliable. Muting that is too wide, e.g., 0-30 degrees, would mean that the sensitivity of the amplitude variation would not be respected. Therefore, it is desired to choose a reflection angle range in which the reflection amplitude does not change significantly. In practice, the reflection angle range Δθ's size is likely to be in the range of 5 degrees to 15 degrees.

The reflection angles may involve muting based on: (1) anticipated reflection angle, dependent on estimated propagation velocity in the subsurface, or (2) user defined mutes based on interpreted horizons such as the waterbottom, or (3) user defined mute function, for example a scaled time(ms)=offset(m) relation.

Any muting of the input data in equation (2) may be used, where different mutes have a substantially different preference to different source-receiver offsets at a given travel time. The examples discussed below show how different reflectivites may be derived based on data muted at different reflection angles.

According to a muted input data embodiment, the multiple modelling of equation (1) is adapted to have a different reflectivity for three reflection angle ranges, defined herein as the near, mid and far reflection angles. Note that the forward propagated input data refers to d_{Φ} in this embodiment. The near reflection angles are considered to be between 0-10 degrees, the mid reflection angles are considered to be between 10 and 20 degrees, and the far reflection angles are considered to be between 20 and 30 degrees. This means that there are three different amplitudes for the reflectivity at a given point in the subsurface, and each amplitude is associated with one of the near, mid and far reflection angles. Dropping the dimensions of each operator in equation (1) for brevity, the angular dependent multiple m can be written as:

$$m = {F}^{- 1} Φ [ \begin{matrix}{D}_{Φ n} & {D}_{Φ m} & {D}_{Φ f}\end{matrix} ] [ \begin{matrix}{r}_{n} \\ {r}_{m} \\ {r}_{f}\end{matrix} ] , \qquad ( 3 )$$

where “n” stands for near, “m” stands for mid, and “f” stands for far. Note that In stands for the reflectivity for the near reflection angles, and the product of the two vectors ([D_{Φn} D_{Φm} D_{Φf}] and reflectivity vector) in equation (3) sums up the near, mid and far reflectivities forward propagated to a position in the subsurface (similar to the schematic in FIG. 3B). This approach is called the muted input data because the vector [D_{Φn} D_{Φm} D_{Φf}] forward propagates muted input data. To determine the optimal reflectivities, the following cost function may be defined, which will be the focus of the optimization problem,

$$ε ( {r}_{n} , {r}_{m} , {r}_{f} ) = {[ d - {F}^{- 1} Φ [ \begin{matrix}{D}_{Φ n} & {D}_{Φ m} & {D}_{Φ f}\end{matrix} ] [ \begin{matrix}{r}_{n} \\ {r}_{m} \\ {r}_{f}\end{matrix} ] ]}^{2} . \qquad ( 4 )$$

Each muted dataset is forward propagated [D_{Φn} D_{Φm} D_{Φf}] to each position in the subsurface, and then each forward propagated dataset reflects using its corresponding reflectivity (rₙ for near-angles, rₘ for mid-angles, and r_{f} for far-angles). The three reflecting wavefields (([D_{Φn} D_{Φm} D_{Φf}]) are combined (summed) and subsequently forward propagated to the surface using propagation operator Φ following which they are reverse Fourier transformed in the time domain.

While equation (4) propagates the input data into the subsurface, then reflects the data and forwards it back to the surface, it is possible to forward propagate the input data and reverse propagate the seismic data d to the subsurface and calculate the error function in the subsurface, as shown in equation (5)

$$ε ( {r}_{n} , {r}_{m} , {r}_{f} ) = {[ {Φ}^{- 1} F d - [ \begin{matrix}{D}_{Φ n} & {D}_{Φ m} & {D}_{Φ f}\end{matrix} ] [ \begin{matrix}{r}_{n} \\ {r}_{m} \\ {r}_{f}\end{matrix} ] ]}^{2} . \qquad ( 5 )$$

The proposed approach allows the reflectivity to vary as a function of the reflection angle, thus respecting the reflection angle amplitude variation of the multiple generator.

In a different approach, the output data is muted and the multiple is determined during a one modelling equation. The multiple modeling is expressed as:

$$m = [ \begin{matrix}{M}_{n} & {M}_{m} & {M}_{f}\end{matrix} ] {F}^{- 1} Φ [ \begin{matrix}{D}_{Φ} & 0 & 0 \\ 0 & {D}_{Φ} & 0 \\ 0 & 0 & {D}_{Φ}\end{matrix} ] [ \begin{matrix}{r}_{n} \\ {r}_{m} \\ {r}_{f}\end{matrix} ] \qquad ( 6 )$$

where the operator [Mₙ Mₘ M_{f}] mutes the data after the input data is forward propagated in the subsurface, reflected, and forward propagated to the surface, i.e., mutes the modelled data. The muting operators may normally be considered square and diagonal matrices. Note that the same forward propagated data d_{Φ} is used for all the reflectivities, which is different from the embodiment of equation (3). Based on equation (6), the following cost function may be used to be the focus of the optimization problem:

$$ε ( {r}_{n} , {r}_{m} , {r}_{f} ) = {[ d - [ \begin{matrix}{M}_{n} & {M}_{m} & {M}_{f}\end{matrix} ] {F}^{- 1} Φ [ \begin{matrix}{D}_{Φ} & 0 & 0 \\ 0 & {D}_{Φ} & 0 \\ 0 & 0 & {D}_{Φ}\end{matrix} ] [ \begin{matrix}{r}_{n} \\ {r}_{m} \\ {r}_{f}\end{matrix} ] ]}^{2} . \qquad ( 7 )$$

In this formulation, unmuted input data is forward propagated to the subsurface (d_{Φ}). The forward propagated input data then reflects from each of the reflectivity volumes (rₙ, rₘ, r_{f}) and is subsequently forward propagated to the surface using operator Φ and reverse Fourier transformed using operator F⁻¹. This produces three wavefields corresponding to each of the three reflectivities: near angle reflectivity F⁻¹ΦD_{Φ}rₙ, mid angle reflectivity F⁻¹ΦD_{Φ}rₘ, and far angle reflectivity F⁻¹ΦD_{Φ}r_{f}.

Each wavefield is then muted based on its representative angle range: for near angle reflectivity MₙF⁻¹ΦD_{Φ}rₙ, for mid angle reflectivity MₘF⁻¹ΦD_{Φ}rₘ, and for far angle reflectivity M_{f}F⁻¹ΦD_{Φ}r_{f}. The three muted wavefields are summed to generate the multiple estimate, m, and subtracted from data, d, to define the cost function. In this case, a single inversion problem is solved to find all three reflectivities (rₙ, rₘ, r_{f}), which combine to model the multiples.

In another approach, the forward propagated data d_{Φ} may be dip filtered using operators (Bₙ, Bₘ, B_{f}), each selecting a different range of propagation angles prior to reflecting in the subsurface:

$$ε ( {r}_{n} , {r}_{m} , {r}_{f} ) = {[ d - {F}^{- 1} Φ [ \begin{matrix}{B}_{n} {D}_{Φ} & {B}_{m} {D}_{Φ} & {B}_{f} {D}_{Φ}\end{matrix} ] [ \begin{matrix}{r}_{n} \\ {r}_{m} \\ {r}_{f}\end{matrix} ] ]}^{2} . \qquad ( 7 a )$$

The dip filter linear operators (Bₙ, Bₘ, B_{f}) may include a scaling in the frequency-wavenumber (fk) domain, for example at each depth-step: 1) forward Fourier transform propagated data from fx-domain to fk-domain, 2) apply a dip-filter scaling function, 3) reverse Fourier transform scaled data from fk-domain to fx-domain. In the FK domain, the propagation angle, θ, may be a function of frequency, f, wavenumber, K, and a reference velocity, v: sin θ=ΞK/2f. The scaling may relate to passing a range of propagation angles with a taper. Alternatively, the scaling may be in the taup domain, curvelet domain, wavelet domain or another domain. The dip filter may also be implemented by a convolution in the fx-domain. Dip filters may pass ranges of angles, for example: Near angles: |θₙ|=0-10 degrees, Mid angles: |θₘ|=10-20 degrees, and Far angles: |θ_{f}|=20-30 degrees. Each dip-filtered forward propagated data may be reflected using the corresponding reflectivity, the results then being combined in the subsurface, and forward propagated to the surface using the forward propagation operator, Φ. Similarly, to the approach given by equation (4), the reflecting wavefields are combined in the subsurface prior to propagation back to the receiver.

In yet another approach, the output data is muted and the multiples are determined by solving three inverse problems, one for each of the near, mid and far reflectivities. More specifically, the multiples for each of the near, mid and far range are modelled independently of each other,

mₙ=MₙF⁻¹ΦD_{Φ}rₙ (8)

mₘ=MₙF⁻¹ΦD_{Φ}rₘ, and (9)

m_{f}=M_{f}F⁻¹ΦD_{Φ}r_{f} (10)

Thus, three different cost functions can be written as,

ε(rₙ)=[dₙ−MₙF⁻¹ΦD₁ rₙ]² (11)

ε(rₘ)=[dₘ−MₘF⁻¹ΦD₁ rₘ]²and (12)

ε(r_{f})=[d_{f}−M_{f}F⁻¹ΦD₁ r_{f}]² (13)

This approach is similar to the previous approach except that the muted modelled data in equations (8) to (10) are not combined within a single inversion error function, but are instead used to define independent cost functions based on muted input data (e.g., dₙ=Mₙd, dₘ=Mₘd, d_{f}=M_{f}d). An inversion problem for each cost function may be solved independently, and subsequently used to model multiples for near, mid, and far offset data. The multiple models for each reflection angle range may be combined prior to subtraction from the seismic data d for generating the demultiple data dd.

Another approach also has three optimization problems, but this time both the input data don and output data is muted. More specifically, the multiples may be written as

mₙ=MₙF⁻¹ΦD_{Φn}rₙ (14)

mₘ=MₘF⁻¹ΦD_{Φm}rₘ, and (15)

m_{f}=M_{f}F⁻¹ΦD_{Φf}r_{f}. (16)

The cost function equations for this case are given by:

ε(rₙ) =[dₙ−MₙF⁻¹ΦD_{Φn}rₙ]² (17)

ε(rₘ) =[dₘ−MₘF⁻¹ΦD_{Φm}rₘ]², and (18)

ε(r_{f}) =[d_{f}−M_{f}F⁻¹ΦD_{Φf}r_{f}]². (19)

The difference with the previous approach is that the input data used for forward propagation into the subsurface has been muted in addition to the modelled data, resulting in three forward propagated wavefields (D_{Φn}, D_{Φm}, D_{Φf}; expressed in convolution matrix form). Note that the angle range used for muting of the input data may be different than the angle range for the output data. For example, the near angle input data muted prior to forwards extrapolation dₙ may have been muted for an angle range of 0-14 degrees, whereas the muting operator Mₙ applied to the modelled data may be of a narrower range, e.g., 0-10 degrees.

The above embodiments may be described as a method for removing multiples m from seismic data d associated with a subsurface 120, and the method includes a step of receiving the seismic data d associated with the subsurface, where the seismic data d includes primaries and multiples m recorded by a receiver, a step of forward propagating the seismic data d into the subsurface to form forward propagated input data, a step of receiving a first angular dependent reflectivity r_{θ1}, associated with a first angular range Δθ₁, in the subsurface, for a given point, and a second angular dependent reflectivity r_{θ2}, associated with a second angular range Δθ₂, in the subsurface for the given point, a step of generating a first reflecting wavefield using the forward propagated input data and the first angular dependent reflectivity r_{θ1}, a step of generating a second reflecting wavefield using the forward propagated input data and the second angular dependent reflectivity r_{θ2}, a step of calculating a multiple model based on (1) the first reflecting wavefield, (2) the second reflecting wavefield, and (3) a forward propagating operator Φ, which is applied to each of the first and second reflecting wavefields, a step of attenuating the multiplies m from the seismic data d by subtraction of the multiple model to calculate demultiple data dd, and a step of generating an image of the subsurface indicative of geophysical features associated with a natural resource (for example, oil or gas resources), carbon capture monitoring or wind turbine placement, based on the demultiple data dd.

The method may further include forward propagating the first reflecting wavefield to the receiver, forward propagating the second reflecting wavefield, independent of the first reflecting wavefield, to the receiver, and combining the forward propagated first and second wavefields at the receiver, to obtain the multiple model. In one application, the method also includes a step of applying a first muting matrix M₁, to the forwards propagated first reflected data, and applying a second muting matrix M₂ to the forwards propagated second reflected data, where the first muting matrix M₁ mutes all data not associated with the first angular dependent reflectivity r_{θ1} and the second muting matrix M₂ mutes all data not associated with the second angular dependent reflectivity r_{θ2}, and a step of summing the muted forward propagated wavefields to calculate the multiples m.

The method may further include, in this or another embodiment, a step of estimating the multiples m by combining the first and second reflecting wavefields D_{Φ1} r_{θ1}, D_{Φ2} r_{θ2} to obtain a combined reflecting wavefield, and propagating the combined reflecting wavefield to the receiver, with the forward propagation operator Φ. The forward propagated input data is dip filtered to a first angular range prior to reflecting from the first angular dependent reflectivity, and the input data is dip filtered to a second angular range prior to reflecting from the second angular dependent reflectivity. The angular dependent reflectivities are calculated with a least square inversion method. The first angular dependent reflectivity may be derived by solving a first inversion problem, and the second angular dependent reflectivity is derived by solving a second inversion problem. The first angular dependent reflectivity and the second angular dependent reflectivity may be derived jointly by solving a single inversion problem. In one application, the first and second angle ranges Δθ₁, Δθ₂ corresponding to the first and second reflectivities r_{θ1} and r_{θ2} are the same as the angle ranges of the first and second muting matrices M₁ and M₂. The first and second angle ranges Δθ₁, Δθ₂ corresponding to the first and second reflectivities r_{θ1} and r_{θ2} are different from the angle ranges of the first and second muting matrices M₁ and M₂.

The steps and optional features discussed above may be implemented into a computing system (to be discussed later) for removing multiples m from seismic data d associated with a subsurface. The computing system includes an interface configured to receive the seismic data d associated with the subsurface, wherein the seismic data d includes primaries and multiples m recorded by a receiver, and a processor connected to the interface and configured to forward propagate the seismic data d into the subsurface to form forward propagated input data; receive a first angular dependent reflectivity r_{θ1}, associated with a first angular range Δθ₁, in the subsurface, for a given point, and a second angular dependent reflectivity r_{θ2}, associated with a second angular range Δθ₂, in the subsurface for the given point; generate a first reflecting wavefield using the forward propagated input data and the first angular dependent reflectivity r_{θ1}; generate a second reflecting wavefield using the forward propagated input data and the second angular dependent reflectivity r_{θ2}; calculate a multiple model based on (1) the first reflecting wavefield, (2) the second reflecting wavefield, and (3) a forward propagating operator Φ, which is applied to each of the first and second reflecting wavefields; attenuate the multiplies m from the seismic data d by subtraction of the multiple model to calculate demultiple data dd; and generate an image of the subsurface indicative of geophysical features associated with a natural resource, carbon capture monitoring or wind turbine placement, based on the demultiple data dd.

The processor may be further configured to forward propagate the first reflecting wavefield to the receiver; forward propagate the second reflecting wavefield, independent of the first reflecting wavefield, to the receiver; and combine the forward propagated first and second wavefields at the receiver, to obtain the multiple model. In one application, the processor is further configured to apply a first muting matrix M₁, to the forwards propagated first reflected data; apply a second muting matrix M₂ to the forwards propagated second reflected data, wherein the first muting matrix M₁ mutes all data not associated with the first angular dependent reflectivity r_{θ1} and the second muting matrix M₂ mutes all data not associated with the second angular dependent reflectivity r_{θ2}; and sum the muted forward propagated wavefields to calculate the multiples m. In this or another embodiment, the processor is further configured to estimate the multiples m by combining the first and second reflecting wavefields D_{Φ1}r_{θ1}, D_{Φ2}r_{θ2} to obtain a combined reflecting wavefield, and propagating the combined reflecting wavefield to the receiver, with the forward propagation operator Φ. The forward propagated input data is dip filtered to a first angular range prior to reflecting from the first angular dependent reflectivity, and the input data is dip filtered to a second angular range prior to reflecting from the second angular dependent reflectivity. The angular dependent reflectivities are calculated with a least square inversion system. The first angular dependent reflectivity is derived by solving a first inversion problem, and the second angular dependent reflectivity is derived by solving a second inversion problem. The first angular dependent reflectivity and the second angular dependent reflectivity are derived jointly by solving a single inversion problem. The first and second angle ranges Δθ₁, Δθ₂ corresponding to the first and second reflectivities r_{θ1} and r_{θ2} are the same as the angle ranges of the first and second muting matrices M₁ and M₂. The first and second angle ranges Δθ₁, Δθ₂ corresponding to the first and second reflectivities r_{θ1} and r_{θ2} are different from the angle ranges of the first and second muting matrices M₁ and M₂.

All the above discussed embodiments correspond to the “sequential” approach and rely on modifying the method in [1] so that a reflectivity varies based on muted data. Next, the “simultaneous” approach implementation of the method illustrated in FIG. 2 is discussed. In one embodiment, it is possible to derive an angle dependent reflectivity, r_{θ}, which is then converted to subsurface offset reflectivity data using an operator S. The subsurface offset reflectivity data is then used to reflect the forward propagated input data to predict multiples in the input data. This approach may be mathematically described as:

m(t,x,y)=F⁻¹Φ(f,x,y,z)D_{Φh}(f,h,x,y,z)S(h, θ)r_{θ}(θ, x,y,z) (20)

ε(r)=[d(t,x,y)−F⁻¹Φ(f,x,y,z)D_{Φh}(f,h,x,y,z)S(h, θ)r_{θ}(θ, x,y,z)]² (21)

where r_{θ}(θ, x, y, z) is the angle dependent reflectivity, which is a function of cartesian spatial coordinates (x, y, z) and reflection angle, θ. As an example, the reflection angle θ may be sampled with increments of between one and ten degrees (i.e., the angle range is between one and ten degrees). The reflection angle may be positive, negative, or positive and negative (e.g., −40, −38, −36, . . . , −2, 0, 2, 4, . . . , 38, 40). It may also include reflection angles outside the 2D plane, for example using a reflection angle and an azimuth. A scalar reflection angle or a signed (+ve and −ve) reflection angle may be used.

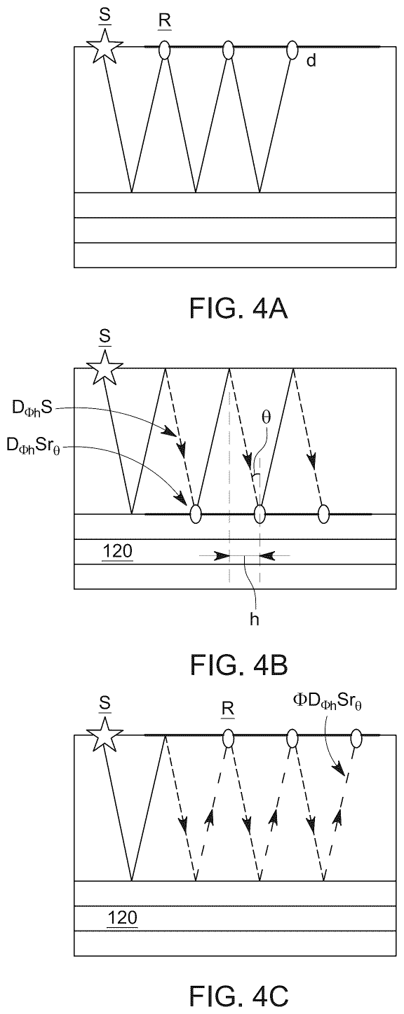

The operator S(h, θ) is called the subsurface offset conversion operator, and is a function of the subsurface offset, h, and angle, θ. The subsurface offset is typically the horizontal distance between the forward propagated seismic data d and the location of the point (x, y, z) where the reflection is supposed to take place. The distance h is illustrated in FIG. 4B. Note that FIGS. 4A to 4C show the extrapolation of the seismic data d and formation of subsurface offset reflection operator operators D_{Φh}. Operator S(h, θ) converts from reflection angle (and optionally azimuth) to subsurface offset. The subsurface offset may be in the x-direction, the y-direction, or the x- and y-directions. Scalar subsurface offsets may also be used. The operator/matrix D_{Φh} reflects the forward propagated wavefield with a reflectivity including subsurface offsets. The operator S(h, θ) is configured to achieve an angle-to-subsurface offset conversion. These two operators are now discussed in more detail.

This method operates on prestack migrated images and produces an output as a function of the subsurface offset h. The S(h, θ) transformation involves reflection angle (and possibly azimuth of reflection angle, dip angle, and azimuth of dip angle). It includes the application of a Radon transform (slant-stack) operator in the (z, θ) domain, based on the angle slope tan(θ) as the trajectory of integration (see, for example, [10]). The operator can be also expressed as a radial-trace transform in the Fourier domain. The approach may be mathematically written as:

rₕ(h, x, y, z)=SlantStack [r_{θ}(θ, x, y, z)], (22)

where rₕ(h, x, y, z) and r_{θ}(0, x, y, z) are the subsurface-offset and angle-dependent reflectivities, respectively. This transformation is based on the following relationship:

$$- \frac{\partial z}{\partial h} {\vert}_{t , x} = tan θ = \frac{{k}_{z}}{{k}_{h}} . \qquad ( 23 )$$

The left-hand side of equation (23) implies a link between constant-slope trajectories in the subsurface offset domain and the reflection angle. The right-hand side defines a counterpart in the Fourier domain. For example, in the space domain (z, h), equation (23) can be defined as:

rₕ(h, x, y, z)=∫dθr_{θ}(θ, x, y, z−htan(θ)). (24)

In this mathematical description, h refers to half offset, and θ refers to half of the reflection angle.

The subsurface offset dependent reflection operator D_{Φh} is defined as the Cartesian offset vector connecting the sunken shot and receiver in the subsurface (see FIG. 4B), in the framework of survey-sinking migration (see, for example, J. F. Claerbout, 1985, Fundamentals of Geophysical Data Processing, Oxford). The subsurface offset extension can be defined as horizontal and vertical coordinates h=(hₓ, h_{y}, h_{z}). The subsurface offset dependent reflection at each depth level (z), involves an interaction of the forward propagated source wavefield at a distance (h) from the fixed point (x, y). For a horizontal extension of subsurface offset h =(hₓ, h_{y}, 0), pseudo-code for operator D_{Φh} at each depth level z may be written as:

```
For subsurface offset hₓ in < min hₓ, max hₓ >
  For local coordinate x in < min x, max x >
    For subsurface offset h_{y} in < min h_{y}, max h_{y} >
      For local coordinate y in < min y, max y >
```

Multiply the forward propagated wavefield at (x−hₓ, y−h_{y}) with the reflectivity at (x, hₓ, h_{y}, y); and

Accumulate the output of the previous step with the reflecting wavefield at (x+hₓ, y+h_{y}).

In this example, the downward propagating wavefield is shifted by −h to produce a reflecting wavefield shifted by +h. This would relate to the full-subsurface offset.

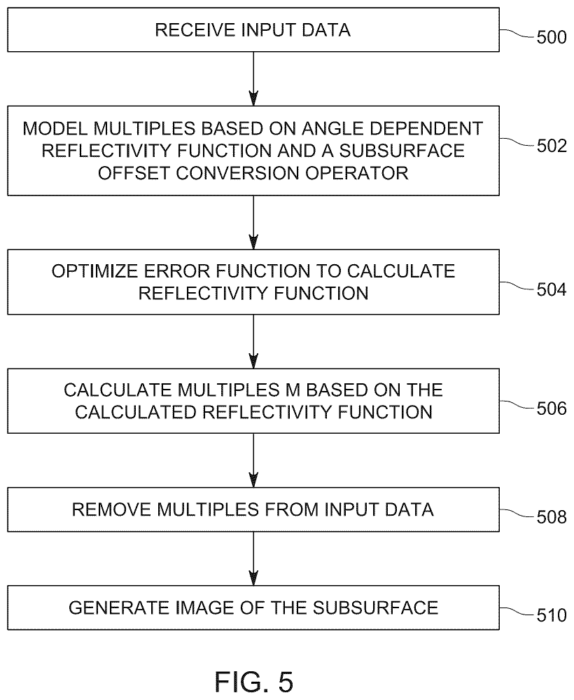

A method that implements this approach is illustrated in FIG. 5 as now discussed. The method receives in step 500 the input data d and then models in step 502 the multiples m based on an angle dependent reflectivity function r_{θ}(θ, x, y, z) modified by a subsurface offset conversion operator S(h, θ), where θ is the reflection angle, x, y, z are the coordinates in the subsurface where the reflection takes place, and h is an offset. The method further includes a step 504 of optimizing an error function ε(r_{θ}) to calculate the reflectivity function r_{θ}, where the error function is a square of a difference between (1) the input data d and (2) the modeled multiples m. In step 506, the method calculates the multiples m based on the calculated reflectivity function r_{θ}, and in step 508 the method removes the multiples m from the input data d, for example, by subtraction, to generate the demultiple data dd. In step 510, the method generates an image of the subsurface based on the demultiple data dd, i.e., the input data d from which the calculated multiples were removed.

In one application, the subsurface offset conversion operator S(h, θ) acts on the angle dependent reflectivity r₇₄ to generate subsurface offset reflectivity data S(h,θ)r_{θ}(θ, x, y, z), where (x, y, z) is a reflection position in the subsurface. The method may further include a step of forward propagating the input data d into the subsurface, to generate forward propagated data d_{Φh} (f, h, x, y, z), reflecting the forward propagated data (note that the forward propagated data d_{Φh} has been changed to the matrix notation Don ready for convolution with the reflectivity) D_{Φh}(f, h, x, y, z) with the subsurface offset reflectivity data S(h, θ)r_{θ}(0, x, y, z) to generate reflected forward propagated data D_{Φh}(f, h, x, y, z)S(h, θ)r_{θ}(θ, x, y, z), and forward propagating the reflected forward propagated data D_{Φh}(f, h, x, y,z)S(h,θ)r_{θ}(θ, x, y, z) with a forward propagation operator Φ to obtain the multiplies m. In one application, the subsurface offset conversion operator S(h, θ) is a Radon transform of the angle dependent reflectivity r₇₄ .

While the method of FIG. 5 was described for marine towed streamer data, the same approach may also be used for ocean-bottom receiver (OBN, PRM, OBS, OBC) or land data. The approach may be applied in the shot domain or in the receiver domain. Shot and receiver sampling may be interchanged based on reciprocity assumptions for any embodiment within this detailed description. The method described above with regard to FIG. 5, i.e., the “simultaneous” approach may also be expressed as follows. The method includes a step of receiving the seismic data d associated with the subsurface, where the seismic data d includes primaries and multiples m recorded by a receiver, a step of forward propagating the seismic data d into the subsurface to form forward propagated data d_{Φ}, a step of receiving angular dependent reflectivities r₇₄ , associated with an angular range Δθ, in the subsurface (120), for a given point, a step of generating an angle dependent reflecting wavefield D_{Φθ}r_{θ} based on the forward propagated data d_{Φ} and the angular dependent reflectivities r₇₄ , a step of calculating a multiple model ΦD_{Φθ}r_{θ} by forward propagating the angle dependent reflecting wavefield D_{Φθ}r_{θ} to the receiver, a step of attenuating multiplies m associated with the multiple model, from the seismic data d, by subtraction of the multiple model to calculate demultiple data dd, and a step of generating an image of the subsurface indicative of geophysical features associated with a natural resource (for example, oil or gas resources), carbon capture monitoring or wind turbine placement, based on the demultiple data dd.

In one application, the associated angular range Δθ is between −50 and +50 degrees. In this or another application, the step of receiving the angular dependent reflectivities r₇₄ includes receiving a first angular dependent reflectivity r_{θ1}, associated with a first angular range, and a second angular reflectivity r_{θ2}, associated with a second angular range, wherein the first angular range together with the second angular range form the angular range Δθ. The angular dependent reflectivities are calculated with a least square inversion method. The multiple model ΦD_{Φθ}r_{θ} is calculated by simultaneously forward propagating plural angle dependent reflecting wavefields D_{Φθ}r_{θ} to the receiver. The step of generating an angle dependent reflecting wavefield involves converting the angle dependent reflectivity to a subsurface offset domain Sr_{θ} and accumulating a reflection from a first subsurface offset with a reflection from a second subsurface offset D_{ΦS}Sr_{θ}. The forward propagated data is offset in space, at the given point, with a subsurface offset h to generate a reflection. The forward propagated data is dip filtered to a first angular range to create a first angular range forwards propagated wavefield. The first angular range forwards propagated wavefield is reflected from a first reflectivity corresponding to the same first angular range. The subtraction is an adaptive subtraction.

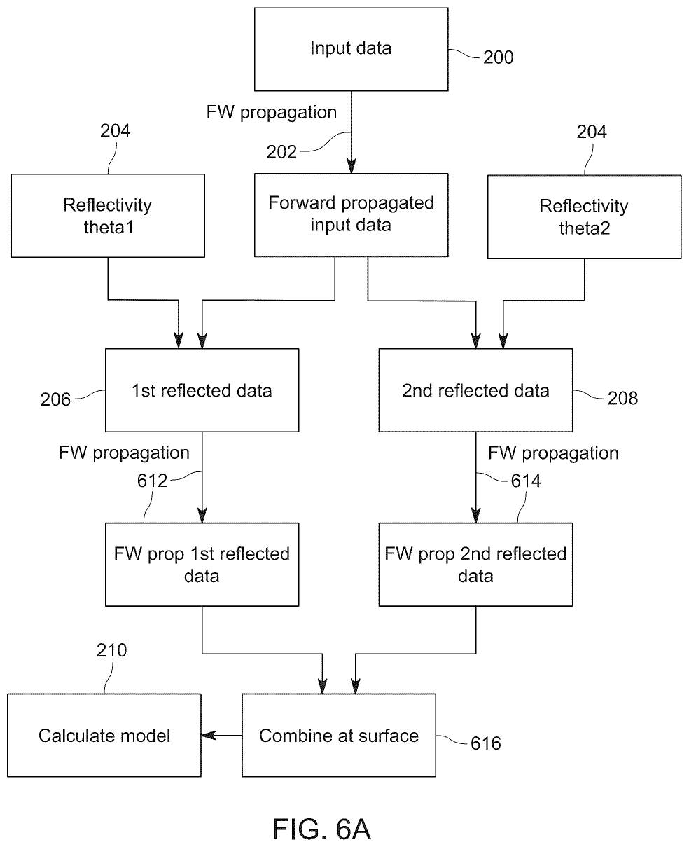

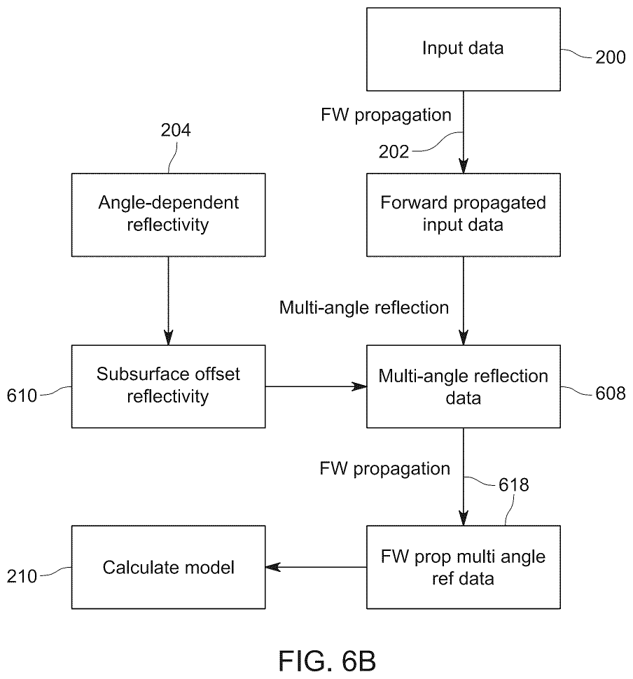

The following figures are used to exemplify the differences between the sequential and simultaneous multiple modelling approaches discussed above with regard to FIGS. 2 and 5. FIG. 6A schematically illustrates the sequential approach and FIG. 6B schematically illustrates the simultaneous approach. FIGS. 6A and 6B show the step 200 of receiving the input data, the step 202 of forward propagating the seismic data into the subsurface to form forward propagated data d_{Φ}, and the step 204 of receiving the angle-dependent reflectivity (e.g., the first and second angular reflectivities) associated with an angular range Δθ for a given point. FIG. 6A shows the step 206 of generating the first reflecting wavefield and the step 208 of generating the second reflecting wavefield. FIG. 6B shows an additional step 610 of generating the subsurface offset reflectivity, while the steps 206 and 208 of generating the first and second reflecting wavefields in FIG. 6A are replaced herein by a step 608 of generating an angle dependent reflecting wavefield D_{Φθ}r_{θ}, based on the forward propagated data d_{Φ} and the angular dependent reflectivities r₇₄ . Note that FIG. 6A shows the two steps 206 and 208 being performed independently while FIG. 6B performs a single step for generating the angle dependent reflecting wavefield Deere. The step 210 of calculating the multiple model for the method of FIG. 6A is based on individually propagating, in steps 612 and 614, the first and second reflecting wavefields and then combining them in step 616, at the surface, while the method in FIG. 6B calculates the multiple model ΦD_{Φθ}r_{θ} by forward propagating all the angle dependent reflecting wavefields D_{Φθ}r_{θ} to the receiver at once. In more detail, the method of FIG. 6B propagates in step 618 the angle dependent reflecting wavefield D_{Φθ}r_{θ} to the surface, and then calculates the multiple model m in step 210. Note that steps 212 and 214 shown in FIG. 2 are omitted in FIGS. 6A and 6B for simplicity. One skilled in the art would understand that the steps shown in FIGS. 6A and 6B may be combined with any of the steps shown in FIG. 2, as appropriate.

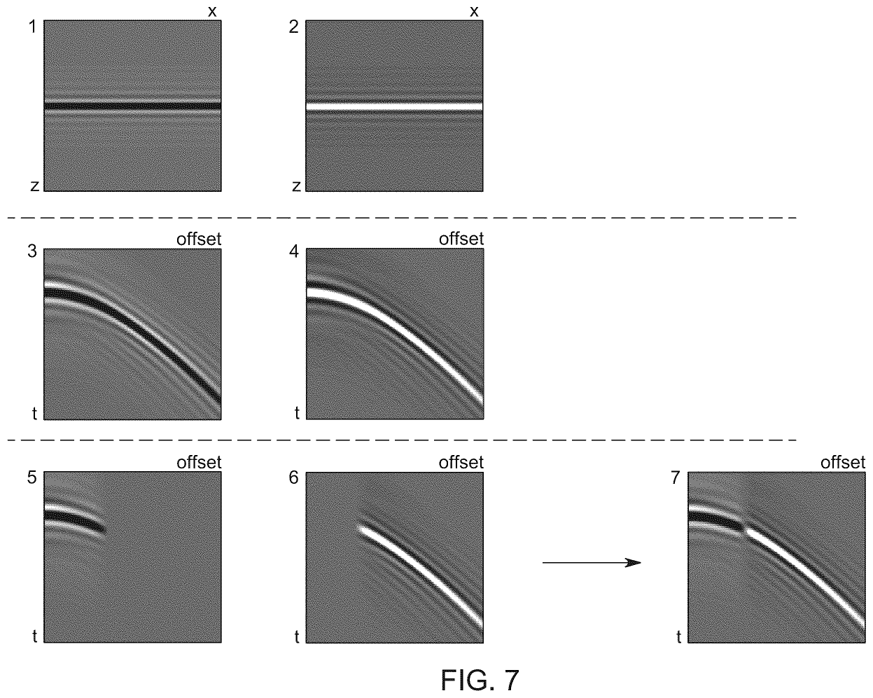

The differences in the methods illustrated in FIGS. 6A and 6B are further illustrated in FIGS. 7 to 9. More specifically, FIG. 7, which illustrates the data and data processing steps associated with the method of FIG. 6A, includes panels 1 and 2, which show the reflectivities r_{θ1} and r_{θ2}, where θ1 corresponds to 0-20 degrees and θ2 corresponds to 20-50 degrees, in this particular case. Other values may be selected for these angles. Panels 3 and 4 illustrate the modeled data at the receivers, and panels 5 and 6 show the muted data, for near and far offsets, respectively, corresponding to the 0-20 and 20-50 degrees angle ranges. Panel 7 illustrates the merged modeled data.

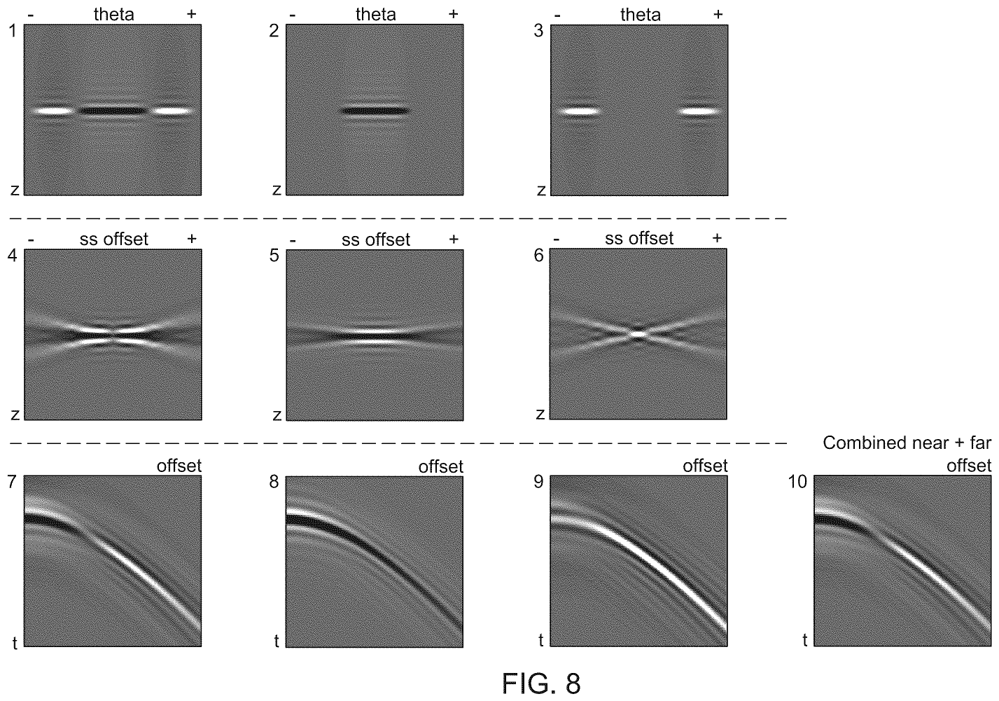

FIG. 8 illustrates the data and data processing steps associated with the method of FIG. 6B. It includes panel 1, which corresponds to the angle domain data for the entire (or full) angle range of −50 to 50 degrees. In one embodiment, the angle domain data is transformed to the subsurface-offset domain (panel 4) which is subsequently used to generate a simultaneous angular-dependent reflection. After the simultaneous angular-dependent reflection is propagated to the surface, panel 7 is produced. For illustration, panel 2 shows the data for the near angle range (e.g., −20 to 20 degrees) while panel 3 shows the data for the far angle range (e.g., −50 to −20 degrees and 20 to 50 degrees). Panels 5 to 6 show the angle domain data from panels 2 to 3 transformed into the subsurface-offset domain, respectively. Note that although panels 2 and 3 in FIG. 8 show the presence of energy only for the specifically selected angle domains, panels 5 and 6 show the presence of energy on all subsurface offsets.

The modeled multiples m are illustrated in panels 7 to 9 in FIG. 8 and correspond to the subsurface-offsets applied in the panels 4 to 6. Panel 10 of FIG. 8 shows the result of combining the near and far offset data at the receiver plane, i.e., panels 8 and 9. Panels 7 and 10 are numerically equivalent, highlighting the equivalence of (1) generating a multi-angle reflection in the subsurface and propagating it to the surface with (2) generating a series of reduced-angle reflections in the subsurface, individually propagating them to the surface, and then combining them at the surface.

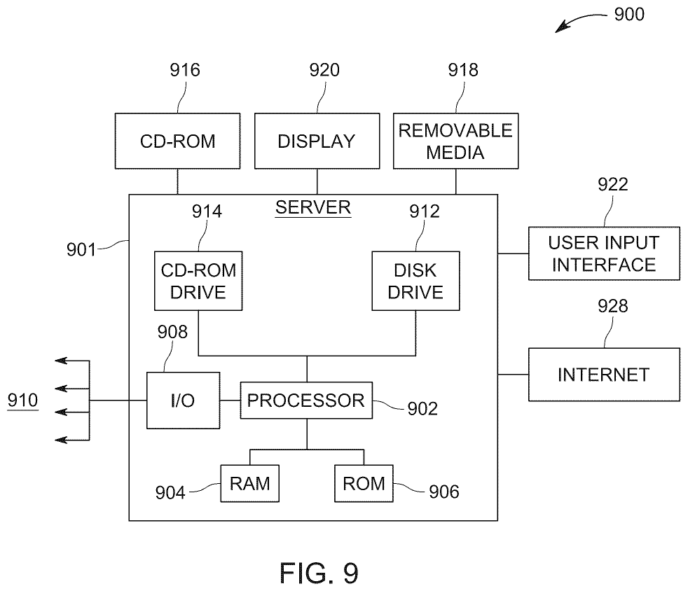

Any of the above discussed methods may be implemented in a computing device, whose schematic is shown in FIG. 9. Hardware, firmware, software or a combination thereof may be used to perform the various steps and operations of the above-described methods. The computing device 900 may include a server 901, which has a central processor (CPU) 902 coupled to a random access memory (RAM) 904 and to a read-only memory (ROM) 906. The ROM 906 may also be other types of storage media to store programs, such as programmable ROM (PROM), erasable PROM (EPROM), etc. The CPU 902 communicates with other internal and external components through input/output (I/O) circuitry 908 and bussing 910, to receive the data acquired using a streamer, OBN, DAS, land nodes, etc. and output one or more of the multiples, the primaries and/or the image of the geological formation. The processor 902 carries out a variety of functions as are known in the art, as dictated by software and/or firmware instructions.

The server 901 may also include one or more data storage devices, including hard drives 912, CD-ROM drives 914, and other hardware capable of reading and/or storing information such as DVD, etc. In one embodiment, software for carrying out the above-discussed methods may be stored and distributed on a CD-ROM or DVD 916, a USB storage device 918 or other form of media capable of portably storing information. These storage media may be inserted into, and read by, devices such as the CD-ROM drive 914, the disk drive 912, etc. Server 901 may be coupled to a display 920, which may be any type of known display or presentation screen, such as LCD, plasma display, cathode ray tubes (CRT), etc. The image of the geological formation or graphs similar to the ones in FIGS. 7 to 9 may be shown on a display 920. A user input interface 922 is provided and may include one or more user interface mechanisms such as a mouse, keyboard, microphone, touchpad, touch screen, voice-recognition system, etc.

Server 901 may be coupled to other devices, such as sources, receivers, etc. The server may be part of a larger network configuration as in a global area network (GAN) such as the Internet 928, which allows ultimate connection to various landline and/or mobile computing devices.

The disclosed embodiments enable processing seismic data that identify multiples. It should be understood that this description is not intended to limit the invention. On the contrary, the exemplary embodiments are intended to cover alternatives, modifications and equivalents, which are included in the spirit and scope of the invention as defined by the appended claims. Further, in the detailed description of the exemplary embodiments, numerous specific details are set forth in order to provide a comprehensive understanding of the claimed invention. However, one skilled in the art would understand that various embodiments may be practiced without such specific details.

Although the features and elements of the present exemplary embodiments are described in the embodiments in particular combinations, each feature or element can be used alone without the other features and elements of the embodiments or in various combinations with or without other features and elements disclosed herein.

This written description uses examples of the subject matter disclosed to enable any person skilled in the art to practice the same, including making and using any devices or systems and performing any incorporated methods. The patentable scope of the subject matter is defined by the claims, and may include other examples that occur to those skilled in the art. Such other examples are intended to be within the scope of the claims.

### REFERENCES

The entire content of all the publications listed herein is incorporated by reference in this patent application.

[1] Poole, G. Shallow water surface related multiple attenuation using multi-sailline 3D deconvolution imaging. 81st EAGE Conference and Exhibition, Extended Abstracts, Tu R1 5.
[2] Berkhout, A. J. and Verschuur, D. J. Estimation of multiple scattering by iterative inversion, Part I: theoretical consideration. Geophysics, 62(5), 1586-1595.
[3] Pica, A., Poulain, G., David, B., Magesan, M., Baldock, S., Weisser, T., Hugonnet, P. and Herrmann, P. 3D surface-related multiple modeling, principles and results. 75th SEG Annual International Meeting, Expanded Abstracts, 2080-2083.
[4] Wang, M., and Hung, B. 3D inverse scattering series method for internal multiple attenuation. EAGE conference and proceedings.
[5] Biersteker, J. MAGIC: Shell's surface multiple attenuation technique. 71^{st} SEG Annual International Meeting, Expanded Abstracts, 1301-1304.
[6] Poole, G., Jin, Z., Irving, A., and Refaat, R. Adaption-free OBN demultiple using up-down deconvolution and wave-equation deconvolution. EAGE conference proceedings.
[7] Aki, K. and Richards P. G. Quantitative seismology: Theory and methods. London: W. H. Freeman & Co, 123-192.
[8] Yilmaz, O. Seismic data analysis. SEG library publication.
[9] Mukhopadhyay, P. and Mallick, S. Exact angle-mute pattern for a transversely isotropic medium with vertical symmetry axis and its implication in offset-to-angle transform. EAGE conference proceedings.
[10] P. Sava and S. Fomel, Angle-domain common-image gathers by wavefield continuation methods, Geophysics, 68, 1065-1074.

[11] Biondi, B. L. 3D seismic imaging. Investigations in Geophysics, Society of Exploration Geophysicists publication.

What is claimed is:

1. A method for removing multiples m from seismic data d associated with a subsurface, the method comprising:
receiving the seismic data d associated with the subsurface, wherein the seismic data d includes primaries and multiples m recorded by a receiver;
forward propagating the seismic data d into the subsurface to form forward propagated data d_{Φ};
receiving angular dependent reflectivities r₇₄ , associated with an angular range Δθ, in the subsurface, for a given point;
generating an angle dependent reflecting wavefield D_{Φθ}r_{θ} based on the forward propagated data d_{Φ} and the angular dependent reflectivities r₇₄ ;
calculating a multiple model ΦD_{Φθ}r_{θ} by forward propagating the angle dependent reflecting wavefield D_{Φθ}r_{θ} to the receiver;
attenuating multiplies m associated with the multiple model, from the seismic data d, by subtraction of the multiple model to calculate demultiple data dd; and
generating an image of the subsurface indicative of geophysical features associated with a natural resource, carbon capture monitoring or wind turbine placement, based on the demultiple data dd.

2. The method of claim 1, wherein the associated angular range Δθ is between −50 and +50 degrees.

3. The method of claim 1, wherein the step of receiving the angular dependent reflectivities r₇₄ includes receiving a first angular dependent reflectivity r_{θ1}, associated with a first angular range, and a second angular reflectivity r_{θ2}, associated with a second angular range, wherein the first angular range together with the second angular range form the angular range Δθ.

4. The method of claim 1, wherein the angular dependent reflectivities are calculated with a least square inversion method.

5. The method of claim 1, wherein the multiple model ΦD_{Φθ}r_{θ} is calculated by simultaneously forward propagating plural angle dependent reflecting wavefields D_{Φθ}r_{θ} to the receiver.

6. The method of claim 1, wherein the step of generating an angle dependent reflecting wavefield involves converting the angle dependent reflectivity to a subsurface offset domain Sr₇₄ and accumulating a reflection from a first subsurface offset with a reflection from a second subsurface offset D_{ΦS}Sr_{θ}.

7. The method of claim 6, wherein the forward propagated data is offset in space, at the given point, with a subsurface offset h to generate a reflection.

8. The method of claim 1, wherein the forward propagated data is dip filtered to a first angular range to create a first angular range forwards propagated wavefield.

9. The method of claim 8, wherein the first angular range forwards propagated wavefield is reflected from a first reflectivity corresponding to the same first angular range.

10. The method of claim 1, wherein the subtraction is an adaptive subtraction.

11. A computing system for removing multiples m from seismic data d associated with a subsurface, the computing system comprising:
an interface configured to receive the seismic data d associated with the subsurface, wherein the seismic data d includes primaries and multiples m recorded by a receiver; and
a processor connected to the interface and configured to,
forward propagate the seismic data d into the subsurface to form forward propagated data d_{Φ};
receive angular dependent reflectivities r₇₄ , associated with an angular range Δθ, in the subsurface, for a given point;
generate an angle dependent reflecting wavefield D_{Φθ}r_{θ} based on the forward propagated data d_{Φ} and the angular dependent reflectivities r_{θ};
calculate a multiple model ΦD_{Φθ}r_{θ} by forward propagating the angle dependent reflecting wavefield D_{Φθ}r_{θ} to the receiver;
attenuate multiplies m associated with the multiple model, from the seismic data d, by subtraction of the multiple model to calculate demultiple data dd; and
generate an image of the subsurface indicative of geophysical features associated with a natural resource, carbon capture monitoring or wind turbine placement, based on the demultiple data dd.

12. The system of claim 11, wherein the associated angular range Δθ is between −50 and +50 degrees.

13. The system of claim 11, wherein the processor is further configured to receive a first angular dependent reflectivity r_{θ1}, associated with a first angular range, and a second angular reflectivity r_{θ2}, associated with a second angular range, wherein the first angular range together with the second angular range form the angular range Δθ.

14. The system of claim 11, wherein the angular dependent reflectivities are calculated with a least square inversion method.

15. The system of claim 11, wherein the multiple model ΦD_{Φθ}r_{θ} is calculated by simultaneously forward propagating plural angle dependent reflecting wavefields D_{Φθ}r_{θ} to the receiver.

16. The system of claim 11, wherein the processor is further configured to convert the angle dependent reflectivity to a subsurface offset domain Sr_{θ} and accumulate a reflection from a first subsurface offset with a reflection from a second subsurface offset D_{ΦS}Sr_{θ}.

17. The system of claim 16, wherein the forward propagated data is offset in space, at the given point, with a subsurface offset h to generate a reflection.

18. The system of claim 11, wherein the forward propagated data is dip filtered to a first angular range to create a first angular range forwards propagated wavefield.

19. The system of claim 18, wherein the first angular range forwards propagated wavefield is reflected from a first reflectivity corresponding to the same first angular range.

20. The system of claim 11, wherein the subtraction is an adaptive subtraction.
